(19) United States
(12) Patent Application Publication
(10) Pub. No.: US 2005/0114461 A1
(43) Pub. Date: May 26, 2005

(54) Method of data exchange processing for sending server and receiving server

(75) Inventors: Yoshinari Shirai, Yokohama (JP); Hideki Gotoh, Yokohama (JP); Mitsuhiro Sato, Yokohama (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/883,897

(22) Filed: Jul. 2, 2004

(30) Foreign Application Priority Data
Sep. 30, 2003 (JP) 2003-340221

(51) Int. Cl. G06F 15/16

(52) U.S. Cl. 709/207

(57) ABSTRACT

The sending server appends the serial number on the same day and the last serial number of data sent lastly on the previous day to the data and sends the data. A receiving server records the sending day and the serial number for received data, verifies the security and stores successful data of the security verification. Also it extracts the missing serial number from the serial numbers of data received on the previous day when the data takes place at the first sending on the day and makes a resending request for data related to the missing serial number to the sending server if the last serial number is unequal to the number of received data on the previous day. The sending server resends the corresponding data to the resending request to the receiving server.

### BACKGROUND OF THE INVENTION

1. Field of the Invention

This invention relates to an electronic commerce supporting system employing the Internet. More particularly, the present invention relates to a method and processing program for implementing a data exchange system capable of sending or receiving data for commerce transaction or business affair reliably, employing an electronic mail system.

2. Description of the Related Art

A system (electronic mail system) for exchanging data such as character message over the Internet may be employed as communication means on the electronic commerce transaction or business affair between companies. The electronic mail (e-mail) system has spread as communication means nowadays when most companies have the environments for using the e-mail system.

However, the e-mail system employing a protocol such as SMTP (Simple Mail Transfer Protocol)/POP (Post Office Protocol) can not support the synchronous communication, unlike other communication protocols such as an interbank settlement system.

This drawback is a problem on the security, and causes other problems that it is difficult to handle the data in the abnormal situation, and there is no recovery means at the time of receive failure. Therefore, the e-mail system is not widely employed as data exchange means on the electronic commerce transactions or business affairs, which take account of the reliable data exchange.

The security problem of the e-mail system has been resolved by the authentication techniques such as encryption of data and signature, and the data leak or tapping prevention techniques with the extended optical line. On the other hand, to enhance the reliability of data exchange in the e-mail system, the e-mail system is provided with a calling side message store and forward system that has a mail box for temporarily storing the e-mail already delivered from the calling party and a called side message exchange system that has a corresponding mail box on the called party, whereby the corresponding e-mail within the mail box on the called party is replaced with the e-mail for correction, when there is any e-mail to be corrected in the mail box on the calling party (see reference document 1: Japanese Patent Laid-Open No.H04-70146).

Along with the spread of the electronic commerce transactions employing the Internet, there is a high demand that the e-mail system that has already widely spread as communication means is also utilized as the data exchange means. However, since the e-mail system has indefinite data transmission route, the send sequence of data is not always completely coincident with the receiving sequence of data. Therefore, it is desired to have a scheme for making the data exchange process at high reliability by assuring the sending and receiving sequences of data coincident while maintaining the simplicity of the e-mail system.

Moreover, it is desired to have a scheme for clarifying the send sequence of data on the receiving side and automatically making the recovery or reacquisition of unreceived data at the time of data receive failure.

Also, it is desired to have a scheme for invalidating the corresponding data, or replacing the sent erroneous data with another corrected data, when there is a situation where the falsely sent data is not left on the receiving side.

Also, since the e-mail system is an open network, it is common to send or receive the data having undergone the encryption and signature authentication to keep the security of data exchange. Though the data is taken out from the mail server, receiving and storing the data may fail on the mail client at the user terminal due to an environment setting error in decoding in the verification process for security of data, an authentication setting error involving certificate update time such as signature, rewriting the mail header due to a virus check application or teamware. On the following recovery by resetting the security verification environment, when the data reception is enabled, the mail client can not receive and store the mail before recovery, and after the recovery time, the mail held by the mail server is received. Consequently, there is a situation where the data sent later is received ahead, but it is required to prevent the switching of receiving sequence.

Moreover, when the data once received from the mail server is deleted due to a misoperation at the mail client, there is no other measure than requesting the sender of the deleted mail to retransmit the mail.

### SUMMARY OF THE INVENTION

It is an object of the present invention to provide a technique for allowing a sending server or a receiving server to control a data exchange process with high reliability by assuring the consistency in the sequencing of sending and receiving the data and the certainty of received data in a data exchange system employing an e-mail system for supporting the electronic commerce transaction.

In order to accomplish the above object, this invention has the following means. The present invention provides a method exchanging data regarding an electronic commerce transaction between the sending server and a receiving server, in which the sending server and the receiving server exchange data asynchronously through an e-mail system, the method comprises 1) a step of appending, to the transmit data, the sending data information including the sending destination information of data, the identification information of the sending server, the identification information of the receiving server, the sending day indicating the month and date when data is sent, the serial number indicating the send sequence of data to each sending destination on the same sending day in consecutive number, and the last serial number that is the serial number of data sent lastly on the previous day of the sending day, 2) a step of performing a security verification for the data, 3) a step of mailing the data, a step of recording the sending data information in a sending management table, 4) a step of storing data sent on the sending day and the previous day in a outgoing data storage section, and 5) a step of taking out the corresponding data of resending object from the outgoing data storage section, employing the sending day and the serial number, and mailing the data of resending object to the receiving server, when a sending request for data specified by the sending day and the serial number is received from the receiving server.

Also, the invention provides a method exchanging the data, the method comprises 1) a step of taking out, from a mail server of the e-mail system, data appended with the sending data information including the sending source information of data, the identification information of the sending server, the identification information of the receiving server, the sending day indicating the month and date when data is sent, the serial number indicating the send sequence of data to each sending destination on the same sending day in consecutive number, and the last serial number that is the serial number of data sent lastly on the previous day of the sending day, 2) a step of recording the sending data information appended to the data and the information managing a receiving situation in a reception management table, 3) a step of performing a security verification for the data, 4) a step of storing successful data of the security verification in a received data storage section, and 5) a step of acquiring the last serial number of the data, when the serial number of the data indicates the first sending on the sending day, and extracting the missing serial number from the serial numbers of data received on the previous day and mailing a resending request for data corresponding to the missing serial number to the sending server, when the last serial number is unequal to the number of received data on the previous day of the sending day that are recorded in the reception management table.

The above methods sending server data exchange processing and the receiving server data exchange processing may be implemented in the sending server and the receiving server, and cooperate in the following manner.

At the sending server, the sending data information including the sending destination information of data, the identification information of the sending server, the identification information of the receiving server, the sending day indicating the month and date when data is sent, the serial number indicating the send sequence of data to each sending destination on the same sending day in consecutive number, and the last serial number that is the serial number of data sent lastly on the previous day of the sending day is appended to the outgoing data.

At the receiving server, data appended with the sending data information is taken out from a mail server of the e-mail system, and the sending data information appended to the data and the information managing a receiving situation are recorded in a reception management table. And security verification for data is performed, and successful data of the security verification is stored in a received data storage section.

Also, the last serial number of the data is obtained, when the serial number of the data indicates the first sending on the sending day, and the missing serial number is extracted from the serial numbers of data received on the previous day and a resending request for data corresponding to the missing serial number is mailed to the sending server, when the last serial number is unequal to the number of received data on the previous day of the sending day that are recorded in the reception management table. Then, at the sending server, the corresponding data of resending object is taken out from the outgoing data storage section, employing the sending day and the serial number, and the data of resending object is sent to the receiving server, when the resending request is received from the receiving server. Thereby, at the receiving server, all the data sent from the sending server can be handled as received according to the send sequence.

Moreover, this invention provides the method for making the data exchange processing in the sending server to send either an invalidation request for invalidating data received and stored within a self-server or a replacement request for replacing the data with the other data, together with the sending day and the serial number for specifying a request object, to the receiving server.

Also, this invention provides the method for making the data exchange processing in the receiving server with the above constitution to delete the corresponding data from the received data storage section if there is an invalidation request, or replace the corresponding data in the received data storage section with another data, if there is a replacement request, when the invalidation or replacement request for data specified by the sending day and the serial number and stored in the received data storage section is received from the sending server.

Using those processing methods, the data stored in the receiving server and specified by the sender can be invalidated or replaced with another data.

Moreover, this invention provides the receiving server data exchange processing method, wherein the receiving server performs the security verification process, further comprises 1) a step of storing and saving the data in an unverified data temporary storage section, and recording the identification information of the data and a cause of save in the management table, when the security verification for the data fails, 2) a step of storing and saving the data sent consecutively from the same sending source as the data and succeeding in the security verification in the rearrangement storage section, and recording the identification information of the data and a cause of save in the management table, and 3) a step of storing the data saved in the unverified data temporary storage section and the data saved in the rearrangement storage section in the received data storage section, when the data saved in the unverified data temporary storage section succeeds in the security verification. Thereby, even when the data not received in the security verification process is verified for security later, the data is received according to the send sequence of data.

With the present invention, the data on the electronic commerce transaction or business affair in which data exchange is made employing the e-mail system is managed according to the send sequence from the sending source on the receiving end, whereby the complete consistency of the sending/receiving sequence is assured.

Therefore, the data for which the receiving sequence is important on the sending destination, such as ordering data, ordering cancel data, and ordering content correction data, for example, is easily dealt with between the companies. Particularly, even when the data receive occurs for a certain period due to a failure of security verification on the receiving side, the receiving sequence of data before and after recovery is assured.

Moreover, when the invalidation for the data from the sending side once stored on the receiving side, or replacement with another data is requested, the invalidation or replacement of the corresponding data is automatically send only by confirming a notified request on the receiving side, whereby the operation load of managing the received data on the administrator is relieved.

### BRIEF DESCRIPTION OF THE DRAWINGS

FIG. 1 is a diagram showing a configuration example of a data exchange system for practicing the present invention;

FIG. 2 is a diagram showing an internal configuration example of a sending control section;

FIG. 3 is a diagram showing an internal configuration example of a receiving control section;

FIG. 4 is a list showing an example of data items in a mail header of data converged in the sending control section;

FIG. 5 is a diagram showing the relationship between each table constituting a receiving management table;

FIGS. 6A to 6C are diagrams showing data configuration examples of the receiving management table;

FIG. 7 is a diagram showing a processing flow of exchanging data between the sending server and the receiving server;

FIG. 8 is a diagram for explaining a process of data reception and security verification at the receiving server;

FIG. 9 is a flowchart showing a processing flow at the sending server;

FIG. 10 is a flowchart showing a processing flow at the receiving server;

FIG. 11 is a flowchart showing a processing flow of a received data assuring process at step S211;

FIG. 12 is a list showing an example of data created by the sending control section of the sending server in a mail format; and

FIG. 13 is a diagram showing an example of data recorded in a receiving management table.

### DETAILED DESCRIPTION OF THE PREFERRED EMBODIMENTS

The preferred embodiments for carrying out the present invention as the best mode will be described below in which a data exchange system between a plurality of branch offices and the head office is employed on the business affairs for sending the ordering data from a branch office to an order receiving administrator at the head office.

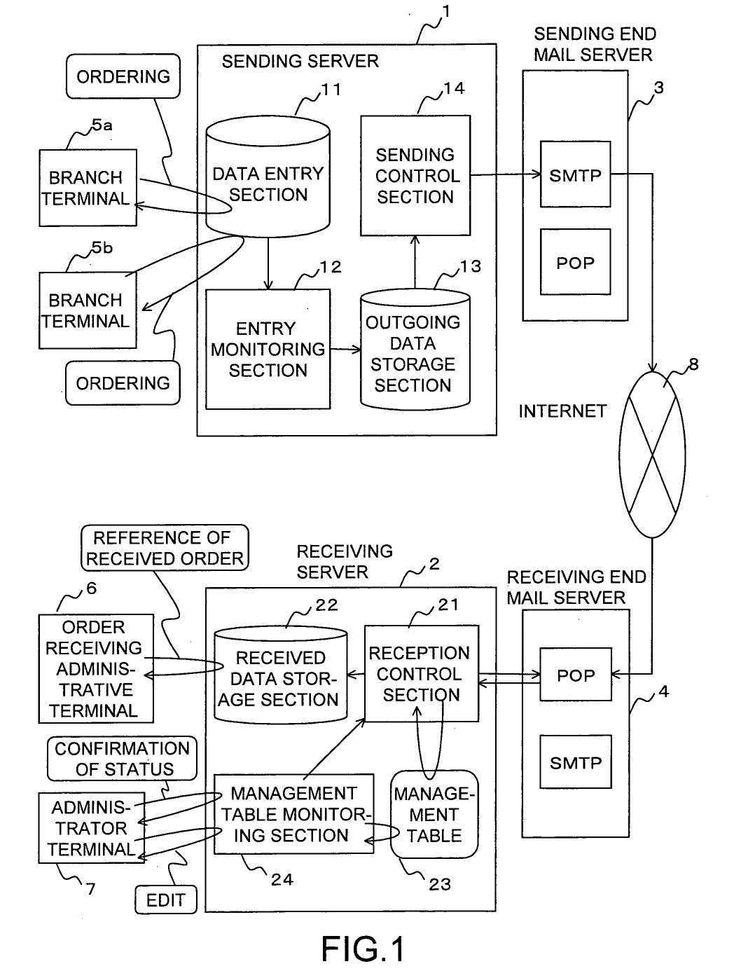

FIG. 1 is a diagram showing a configuration example of the data exchange system for practicing the present invention. The data exchange system comprises a sending server 1, a receiving server 2, a sending end mail server 3, a receiving end mail server 4, the branch terminals 5a, 5b, an order receiving administrative terminal 6, and an administrator terminal 7.

The sending server 1 and the receiving server 2 serve to exchange data between the branch terminals 5a, 5b and the order receiving administrative terminal 6 at the head office via an e-mail system, which is composed of the sending end mail server 3 and the receiving end mail server 4 for exchanging data in e-mail format over the Internet 8 in accordance with the SMTP/POP. The sending server 1 controls the data sending at the branch terminals 5a, 5b for the client, and the receiving server 2 controls the data reception at the order receiving administrative terminal 6 for the client.

The sending server 1 accepts outgoing data to be sent from the branch terminals 5a, 5b to the order receiving administrative terminal 6, appends predetermined sending data information including the sending day indicating the month/date of sending and the consecutive number (serial number) indicating the send sequence of data on the same sending day for each sending destination (sending destination address) of accepted data, converts data into the e-mail format, and sends the outgoing data through the sending end mail server 3. Also, the sending server 1 accepts a resending request from the receiving server 2 for controlling the data reception at the sending destination, and sends the corresponding data again.

The receiving server 2 manages the data reception for all the data sent through the receiving end mail server 4 to the order receiving administrative terminal 6, while assuring the send sequence from each sending source. For example, in a unit of sending date, the number of received data on the previous day is checked, and if there is any unreceived data, a resending request for data is notified to the sending server 1 at the sending source of data. Also, the receiving server 2 makes the invalidation or replacement for data requested from the branch terminals 5a, 5b. The invalidation is a process for invalidating or deleting data from the branch terminals 5a, 5b managed by the receiving server 2 so that the order receiving administrative terminal 6 can not refer to the data. The replacement is a process for replacing data from the branch terminals 5a, 5b managed by the receiving server 2 with the data received together with a replacement request.

The branch terminals 5a, 5b are connected to the sending server 1 and enter a data sending request to the order receiving administrative terminal 6, or an invalidation request or replacement request for sent data.

The order receiving administrative terminal 6 is connected to the receiving server 2 to refer to the received data from the branch terminals 5a, 5b managed by the receiving server 2.

The administrator terminal 7 is connected to the receiving server 2 to manage the situation of data reception or security verification in the receiving server 2.

The sending server 1 comprises a data entry section 11, an entry monitoring section 12, an outgoing data storage section 13, and a sending control section 14.

The data entry section 11 is processing means for storing an invalidation request or replacement request for data entered from the branch terminals 5a, 5b, or the sent data, to the order receiving administrative terminal 6 as the sending destination.

The entry monitoring section 12 is processing means for monitoring the data storage state within the data entry section 11, in which the stored data is gathered for each sending destination, and stored in the outgoing data storage section 13.

The sending control section 14 is means for controlling the sending of data stored in the outgoing data storage section 13.

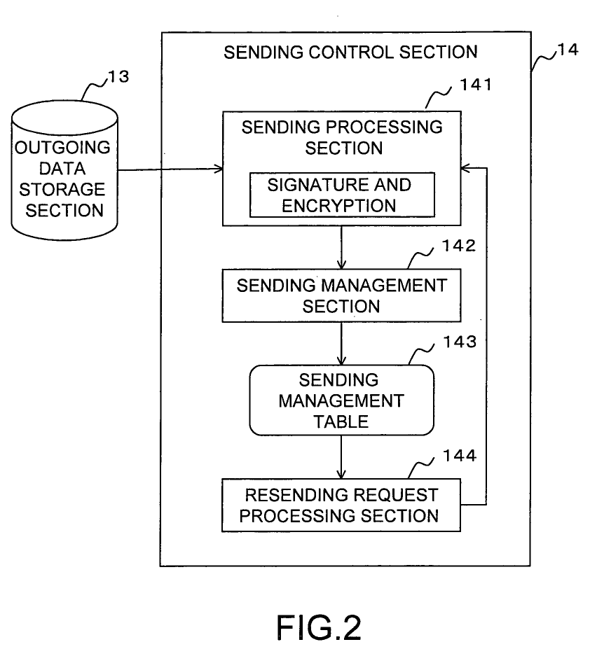

FIG. 2 shows an internal configuration example of the sending control section 14. The sending control section 14 comprises a sending processing section 141, a sending management section 142, a sending management table 143, and a resending request processing section 144.

The sending processing section 141 is means for taking out data from the outgoing data storage section 13, appends the information (sending data information) required for the data sending and the management of data reception at the receiving server 2, converting data into e-mail format data to be destined to the order receiving administrative terminal 6 as the sending destination, performing a security verification process of signature authentication and encryption, and making a mail sending request for data to the sending end mail server 3.

The sending data information includes the general information required for the mail sending, such as sending day and time, sending destination address and sending source address, the service name for identifying the sending, the sending type indicating the normal data sending or request, the data name (file name) for identifying the data, the identification information of the sending server 1 for controlling the data sending at the sending source, the identification information of the receiving server 2 for controlling the data reception at the sending destination, the consecutive number (serial number) indicating the send sequence on the same sending day for each sending destination, and the final number indicating the serial number of data sent lastly on the previous day of sending day. Also, in the case of the invalidation request or replacement request, the information for designating data of request object, and the notification of request completion are added to data as the sending data information. The sending data information is described in a mail header or mail text.

Also, the sending processing section 141 takes out the sending data information of request object from the sending management table 143 via the sending management section 142, when the data taken out from the outgoing data storage section 13 is invalidation request or replacement request, creates an invalidation request or replacement request in the e-mail format to the receiving server 2 of request source as the sending destination, based on the sending data information taken out, and makes a request for mail sending to the sending end mail server 3. Also, the sending processing section 141 accepts a resending request from the resending request processing section 144, takes out the data of request object from the outgoing data storage section 13, converts the request into data in the e-mail format to the receiving server 2 of request object as the sending destination by referring to the corresponding sending data information in the sending management table 143, and makes a request for the mail sending to the sending end mail server 3.

The sending management section 142 is means for managing the sending data information of data sent from the sending processing section 141 that is stored in the sending management table 143.

The resending request processing section 144 is means for receiving a resending request from the receiving server 2, and making a resending request for data of request object to the sending processing section 141.

The receiving server 2 comprises a reception control section 21, a received data storage section 22, a management table 23, and a management table monitoring section 24.

The reception control section 21 is means for taking out data sent to the receiving end mail server 4, controlling the reception to hold the send sequence of data and the security, and storing reception completed data in the received data storage section 22.

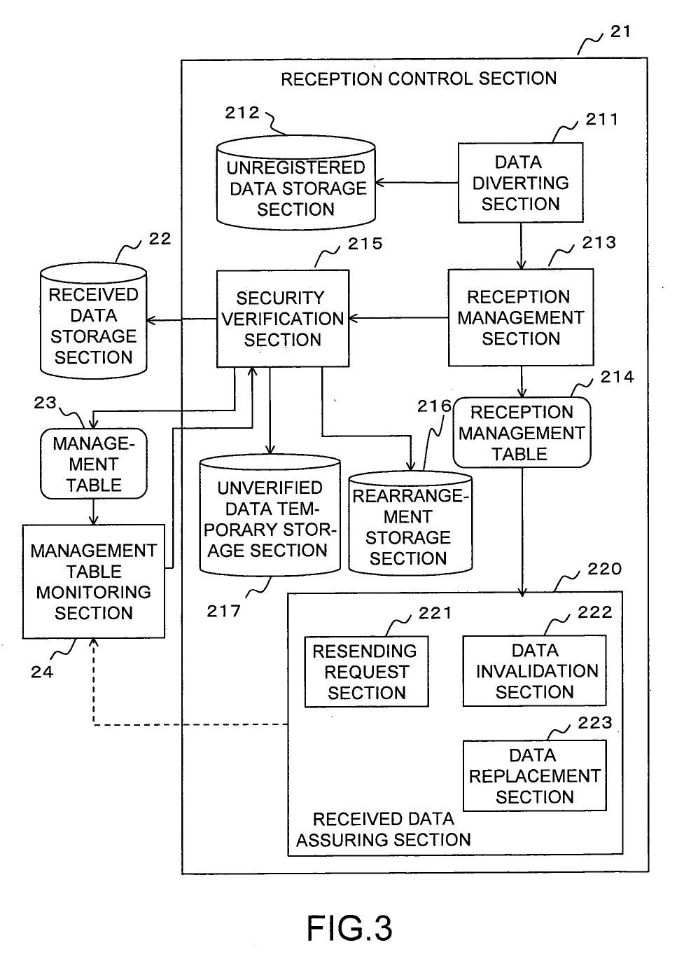

FIG. 3 shows an internal configuration example of the reception control section 21. The reception control section 21 comprises a data diverting section 211, an unregistered data storage section 212, a reception management section 213, a reception management table 214, a security verification section 215, a rearrangement storage section 216, an unverified data temporary storage section 217, and a received data assuring section 220.

The data diverting section 211 is means for determining whether or the sending source of data taken out from the receiving end mail server 4 is registered subscriber (e.g., branch terminals 5a, 5b), and storing data of which the sending source is not registered subscriber in the unregistered data storage section 212. The data stored in the unregistered data storage section 212 is discarded at every predetermined period, or upon an instruction of the administrator.

The reception management section 213 is means for managing the data taken out from the receiving end mail server 4, the information for designating the data sending, and the information regarding the reception situation (received data information) that are stored in the reception management table 214.

The received data information includes the sending data information (sending day and time, sending destination address, sending source address, service name, data name (file name), identification information of sending server 1, identification information of receiving server 2, serial number, and final number) extracted from the received data, data storage information within the receiving server 2, a flag indicating the security verification situation, a flag indicating the request content and its processing situation, and a flag indicating the reception completion or not.

The security verification section 215 is means for verifying the security for the data taken out from the receiving end mail server 4 through a predetermined decoding or signature authentication process.

Also, the security verification section 215 stores successful data of security verification in the received data storage section 22. Also, it stores faulty data of security verification in the unverified data temporary storage section 217, and records data stored in the unverified data temporary storage section 217 and the save reason (e.g., “decoding error”, “signature authentication error” and so on) in the management table 23.

The data sent from the same sending source, following the faulty data of security verification, but succeeding in security verification, is stored in the rearrangement storage section 216, and the data stored in the rearrangement storage section 216 and the save reason (e.g., “initial data save” and so on) are recorded in the management table 23.

The security verification section 215 moves the successful data of verification and the data sent from the same sending source and stored in the rearrangement storage section 216 to the received data storage section 22, when the data stored in the unverified data temporary storage section 217 succeeds in security verification.

The received data storage section 22 is means for storing the data succeeding in security verification and completed to receive. The received data storage section 22 stores the data for each sending source to be referred to according to the serial number (send sequence).

The management table 23 is a data table recording the information indicating the presence or absence of failure in security verification, and the information indicating the presence or absence of invalidation request or replacement request in the reception control section.

The management table monitoring section 24 is means for checking the management table 23 at every predetermined period or moment, and making a rerun request for security verification for the data kept stored in the unverified data temporary storage section 217 for a definite period or more. Also, the management table monitoring section 24 displays the management table 23 at the administrator terminal 7, upon an instruction of the administrator terminal 7, to present the state of reception uncompleted data in the receiving server 2 to the administrator. Also, the management table monitoring section 24 notifies the administrator terminal 7 that there is an invalidation request or replacement request in the management table 23, if any.

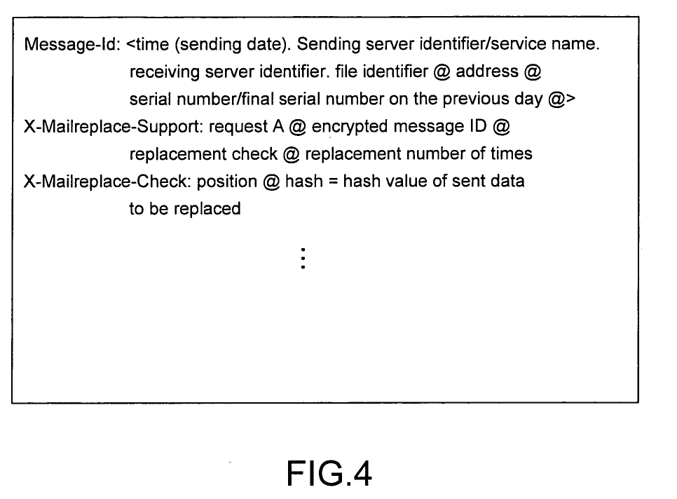

FIG. 4 shows an example of data items in a mail header of data converted in the sending control section 14.

A message ID (Message-Id) is set up in the mail header, as shown below. Also, in the case of the replacement request, a replacement request (X-Mailreplace-Support) and a replacement confirmation (X-Mailreplace-Check) are added as the extended description of the header;

Message ID (Message-Id): <time, sending server identifier/service name, receiving server identifier, file identifier @ address @ serial number/final serial number on the previous day @ >;

Replacement request (X-Mailreplace-Support): request A @ encrypted message ID @ replacement check @ replacement number of times; and

Replacement confirmation (X-Mailreplace-Check): position @ hash=hash value;

The time of “message ID” is the date and time information of mail sending. The sending day is extracted from the time. The sending server identifier is the identification information of the sending server 1 for controlling the sending source to transmit data. The service name is the process name for designating one sending or receiving. The receiving server identifier is the identification information of the receiving server 2 for controlling the sending destination to receive the data.

The file identifier is the identification information of a file specified at the branch terminals 5a, 5b in which the outgoing data is stored at the sending destination. The serial number is the value indicating the send sequence of data on the same sending day for each sending destination. The consecutive number is attached with the first issue as “001”. The last serial number on the previous day is the serial number of data sent lastly to the sending destination on the previous day of the sending day of data.

The request A of “replacement request” is the identifier indicating whether or not a request is made to the administrator A. When a replacement request is made to the administrator A, “replaceA” is set up. The replacement check is a judgement flag for identifying whether or not a request for notification of replacement processing result is made. If “Yes” is set up, a completion notice from the receiving server 2 is returned by mail to the sending server 1 after completion of the replacement processing. Thereby, the completion of data replacement is noticed. The number of replacements is the number of times that the replacement request for the same data is made. If the number of replacements is the same, the replacement request is not applied again.

The position of “replacement confirmation” is the identifier indicating whether the description position of information regarding the replacement request is the mail header or body. The hash is the hash value of data already sent and replaced. The hash value allows the receiving server 2 to check whether or not the data is replacement object (replacement source).

In the case of an invalidation request, the same information as replacement request is set up as the extended description of header, and the “nullifyA” is set up in the request. Also, in the case of a resending request from the receiving server 2, the same information as the replacement request is described. In the case of resending request, “rereceive” is set up in the request.

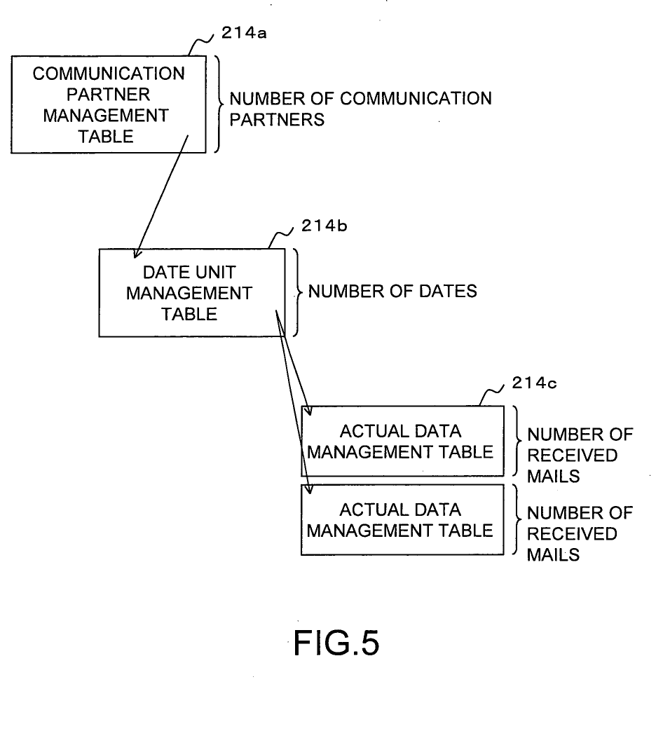

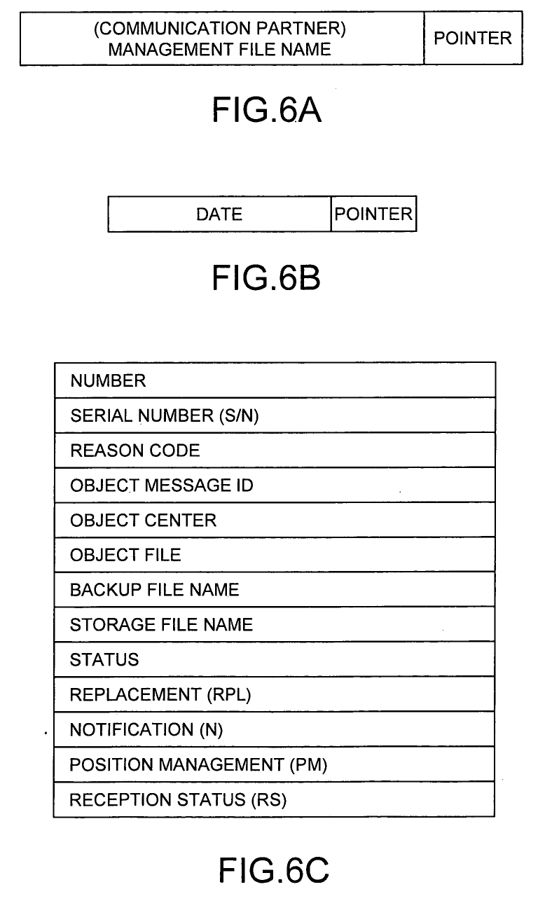

FIGS. 5, 6A, 6B and 6C show a data configuration example of the reception management table 214. The reception management table 214 comprises a communication partner management table 214a, a date unit management table 214b, and an actual data management table 214c.

The communication partner management table 214a is a list for managing the access information to the date unit management table 214b for each sending source (sending source address) as the communication partner, and containing the records corresponding to the number of communication partners. As shown in FIG. 6A, the communication partner management table 214a has the entries of communication partner management file name (management file name) and position for each communication partner. The communication partner management file name is the management file name corresponding to each sending source address (branch terminals 5a, 5b) that is prepared, the position indicating the storage position of the date unit management table 214b for the communication partner.

The date unit management table 214b is the table for managing the access information to the actual data management table 214c beginning from the sending day to extract the actual data received on each sending day, and containing records corresponding to the number of sending dates. As shown in FIG. 6B, the date unit management table 214b has the entries of sending date and position. The position on each sending date (day) indicates the storage position of the actual data management table 214c corresponding to the sending date.

The actual data management table 214c is the table for managing the information regarding the received data, such as the information designating the received data, the storage position of received data, the state of security verification of received data or request processing, and the receiving state, and containing the records corresponding to the number of received mails. As shown in FIG. 6C, the actual data management table 214c includes the number, serial number, reason code, object message ID, object center, object file, backup file name, storage file name, status, replacement (RPL), notification (N), position management (PM), and reception status (RS).

The number is the entry number of record in the actual data management table 214c. The serial number is the serial number described in the message ID of data. The reason code is the reason for the data unreceived state, namely, the state in which data is stored in the received data storage section 22. The object message ID is the message ID of object. The object center is the identification information of the sending server 1 sending the data. The object file is the file identifier described in the data message ID, namely, the name of file in which the data is stored on the side of the receiving server 2. The backup file name is the backup file name of data managed by the receiving server 2. The backup file name may be also the storage information of data in the rearrangement storage section 216 or the unverified data temporary storage section 217. The storage file name is the position information at which data is intrinsically stored after completion of reception. That is, it is the storage information of data in the received data storage section 22. The status is the current processing result of security verification for data. The replacement is the judgement flag indicating the replacement request or not. If it is “Yes”, it is indicated that data is associated with the replacement request. The notification is the judgement flag indicating whether or not the completion of replacement is notified. If it is “Yes”, the replacement is notified to the sending server 1 after replacement. The position management is the information indicating the data position. The “initial reception (INT_RCV)” indicates the initial position of received data, and the “initial replacement (INT_RPL)” indicates the initial position of data stored in the rearrangement storage section 216. The reception status indicates the completion of receiving data, namely, whether or not data is stored in the received data storage section 22.

The received data assuring section 220 is means for assuring the data to be received on the previous day and the send sequence of received data, and invalidating or replacing the received data upon request. The received data assuring section 220 comprises a resending request section 221, a data invalidation section 222 and a data replacement section 223.

The resending request section 221 is means for acquiring the final serial number on the previous day described in the message ID, when the received data is the initial data on the sending date, and if the number of received data on the previous day recorded in the receiving management table 214 is not equal to the final serial number, extracting the missing serial number from the serial number of received data on the previous day recorded in the receiving management table 214, and mailing a resending request to the sending server 1 for the data specified based on the previous date and the missing serial number. The data invalidation section 222 is means for deleting the data described in the invalidation request from the received data storage section 22, when a mail of invalidation request is received. The data replacement section 223 is means for replacing the data described in the replacement request with the mail affixed to the replacement request, when a replacement request is received.

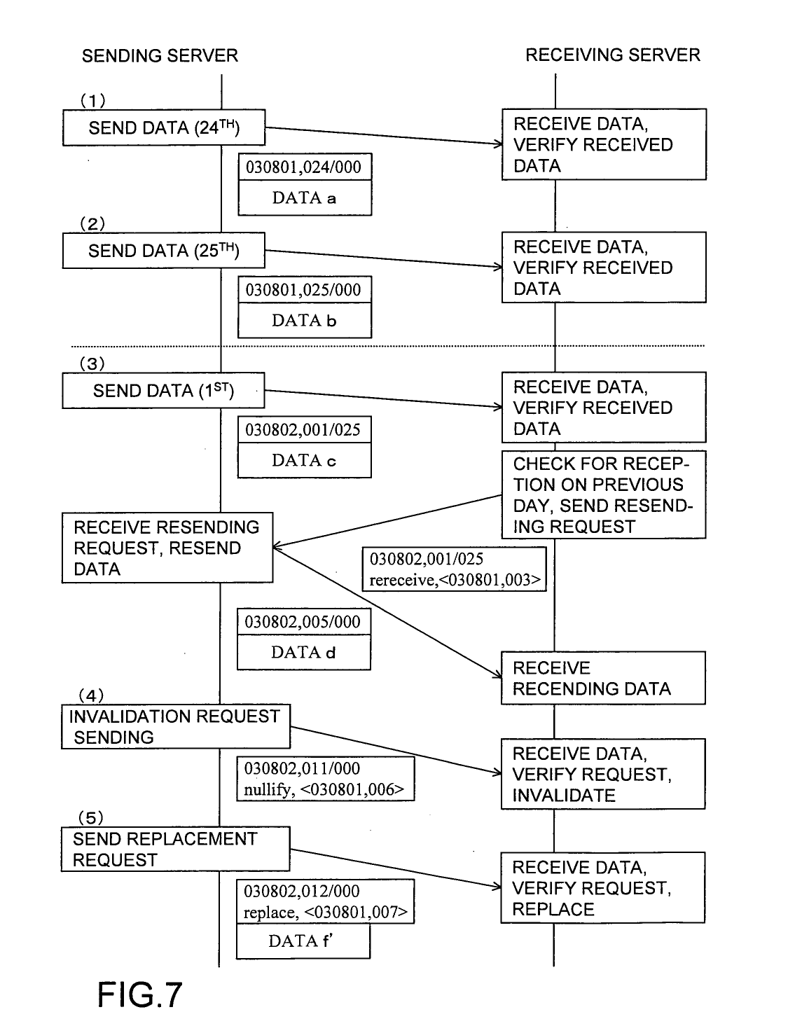

A process for sending ordering data from the branch terminal 5a to the ordering administrative terminal 6 at the head office will be described below. FIG. 7 shows a processing flow of data exchange between the sending server 1 and the receiving server 2.

(1) The branch terminal 5a enters ordering data into the data entry section 11 at the sending server 1. The entry monitoring section 12 at the sending server 1 monitors the data entry section 11 at every predetermined period, gathers the ordering data entered separately into the data a for each sending destination and stores it in the outgoing data storage section 13. The sending processing section 141 of the sending control section 14 takes out the data a stored in the outgoing data storage section 13. Herein, suppose that sending of data a occurs at the 24th time on Aug. 1, 2003. The sending processing section 141 gives the serial number “024” of data a, based on the serial number “023” of data sent immediately before from the sending management table 143 via the sending management section 142. Also, the last serial number on the previous day is set at “000” because the sending of data a is not the first data sending on the sending date. In the message ID of the mail header, the sending data information such as the identifier of sending server 1, identifier of receiving server 2, sending destination (order receiving administrative terminal 6) address, sending date, serial number, and the final serial number on the previous day is described. Moreover, data a with signature authentication and encryption is sent via the e-mail system to the order receiving administrative terminal 6. The encrypted data a is sent to the sending end mail server 3. Also, the sending management section 142 records the sending data information of data a in the sending management table 143.

The receiving server 2 takes the data a sent via the e-mail system to the order receiving administrative terminal 6 from the receiving end mail server 4. The data diverting section 211 determines whether or not the sending source of data a is the registered subscriber. Suppose that the sending source (branch terminal 5a) of data a is registered in advance. The reception management section 213 extracts the sending date, identifier of the sending server 1, file name of data, serial number, and the final serial number on the previous day from the mail header of data a and stores such information in the reception management table 214. Also, the security verification section 215 decodes the received data a and makes the security verification such as signature authentication. When the data a is successful in the security verification, the decoded data a is stored in the received data storage section 22. The reception management section 213 records the storage file name of data a, the receiving status “already received” and so on in the reception management table 214.

(2) The sending server 1 sends the data b to the order receiving administrative terminal 6 through the same operation as in (1). The sending processing section 141 gives the serial number “025” of data b, based on the serial number “024” of data a, sets up the sending data information in the mail header of data b, and mails data b with signature authentication and encryption. The sending management section 142 records the sending data information in the sending management table 143.

The receiving server 2 takes the data b from the receiving end mail server 4. The security verification section 215 stores the data b in the received data storage section 22, if the security verification for data b is successful. The reception management section 213 extracts the same information as in (1) from the mail header, and records it in the reception management table 214.

(3) On the next day (Aug. 2, 2003), the sending control section 14 at the sending server 1 takes out data c stored in the outgoing data storage section 13. Herein, suppose that the data c is sent at the first time on this sending date. The sending processing section 141 acquires the last serial number “025” of transmit data on the previous day (August 1) from the sending management table 143 via the sending management table 142, with the serial number of sending the data c as “001”. And in the mail header of the data c, the sending date (030802), serial number (001) and the last serial number (025) on the previous day are set up, and the data c with signature authentication and encryption is mailed. The sending management section 142 records the sending data information of data c in the sending management table 143.

In the receiving server 2, after data is diverted by the data diverting section 211, the reception management section 213 records the predetermined information in the reception management table 214 in the same manner as the processing of (1). The security verification section 215 makes the security verification for data c, and if the verification is successful, the data c is stored in the received data storage section 22.

And the received data assuring section 220 takes out the last serial number “025” on the previous day from the mail header of data c and obtains the number of received data on the previous day (August 1) from the reception management table 214. If the number of received data on the previous day is unequal to the last serial number on the previous day, the missing serial number is extracted from the serial numbers of received data on the previous day in the reception management table 214. For example, if the serial number “003” is missing, a resending request containing the following contents is created and mailed to the sending server 1:

“request=resending (rereceive), <sending data information (sending delivery date=030801, serial number=003) for resending request object data>”.

The resending request processing section 144 at the sending server 1 receives a resending request from the receiving server 2, and sends the sending request to the sending processing section 141. The sending processing section 141 takes out the specified data d from the outgoing data storage section 13. Also, the encrypted sending data information (030801, 003) at the first sending of data d that is obtained from the sending management table 143 via the sending management section 142, the sending date “030802” and the serial number “005” at the present sending are set up in the mail header, and resent to the receiving server 2.

In the receiving server 2, if the resent data d is taken out from the receiving end mail server 4, the security verification section 215 makes the security verification, and stores the decoded data d in the received data storage section 22. Also, the reception management section 213 extracts the predetermined information such as sending date and time, serial number and so on from the mail header the data d, and records it in the reception management table 214. Herein, since the sending data information at the first sending is set up in the mail header of the data d, the data d is treated as the data with the serial number “003” on Aug. 1, 2003.

(4) On the other hand, suppose that the data e with the serial number “006” sent on the previous day (030801) is sent to a false sending destination from the branch terminal 5a. If the branch terminal 5a enters an invalidation request for data e to be invalidated in the data entry section 11, the entry monitoring section 12 transfers the invalidation request to the outgoing data storage section 13. The sending processing section 141 at the sending server 1 obtains the sending data information of data e to be invalidated from the sending management table 143, based on the invalidation request taken out from the outgoing data storage section 13, and sends the invalidation request including the following contents to the receiving server 2:

“request=invalidation (nullify)A, <sending data information (sending date=030801, serial number=006, . . . ) for data e>”.

The sending data information for data e may be encrypted and sent.

The receiving server 2 takes out a mail of invalidation request from the receiving end mail server 4, and if the security verification for the invalidation request by the security verification section 215 is successful, the invalidation request of data e is registered in the management table 23. If the management table monitoring section 24 finds the invalidation request by monitoring the management table 23, the invalidation request for data e is notified to the administrator A. Thereby, the administrator A can know the invalidation request for data e. When the administrator A acknowledges the invalidation request for data e, the data invalidation section 222 of the received data assuring section 220 deletes the corresponding data e from the received data storage section 22, and records invalidated in the data e of the reception management table 214.

(5) Also, suppose that the data f with the serial number “007” sent on the previous day (030801) has false contents at the branch terminal 5a. The branch terminal 5a enters the corrected data f and the replacement request in the data entry section 11. The entry monitoring section 12 transfers the replacement request and the data f to the outgoing data storage section 13. The sending processing section 141 at the sending server 1 obtains the sending data information for object data f from the sending management table 143, based on the replacement request taken out from the outgoing data storage section 13, obtains the hash value of data f extracted from the outgoing data storage section 13, and mails the replacement request including the following contents to the receiving server 2:

“request=replacement (replace)A, <sending data information (sending date=030801, serial number=007) for data f>, hash value of data f”.

The receiving server 2 takes out the replacement request from the receiving end mail server 4, and enables the security verification section 215 to obtain the data f from the received data storage section 22 and calculate the hash value, and check the hash value described in the replacement request. If other security verifications are successful, the replacement request is registered in the management table 23. If the management table monitoring section 24 finds the replacement request by monitoring the management table 23, the replacement request is notified to the administrator A. Thereby, the administrator A can know the replacement request for data f.

When the administrator acknowledges the replacement request for data f, the data replacement section 223 of the received data assuring section 220 replaces the data f stored in the received data storage section 22 with the sent data f, and records replaced in the data f of the reception management table 214.

Though it was conventionally not known on the side of the receiving server 2 that the data d has been sent, it is possible in this invention to check the serial number of received data on the previous day to find that the data d to be received has not been received and make a resending request for data d to the sending server 1 of data sending source. Therefore, the receiving server 2 can store the data to be received by the order receiving administrative terminal 6 in the send sequence at the branch terminal 5 in the received data storage section 22, keeping the certainty and sequencing of data exchange in the data exchange system.

Also, when the data already received is invalidated or replaced upon a request from the sending source, the administrator of the receiving server 2 only acknowledges the request from the sending source to automatically retrieve the data of request object at the receiving server 2 and invalidate or replace the corresponding data, whereby the administrator is relieved of the load of received data management.

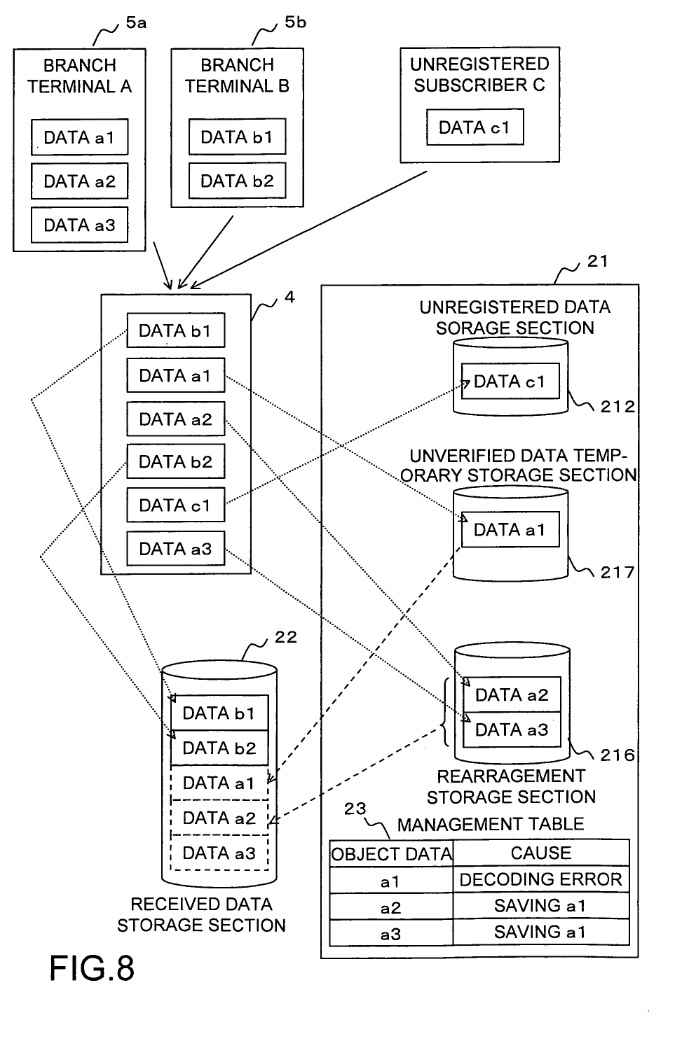

FIG. 8 is a diagram for explaining a process for data reception and security verification at the receiving server 2.

Suppose that the sending server 1 sends two data b at the branch terminal 5b in the order of data b1 and data b2, and three data a at the branch terminal 5a in the order of data a1, data a2 and data a3 to the order receiving administrative terminal 6. Also, suppose that at the receiving end mail server 4, are stored in the order of data b1, data a1, data a2, data b2, data c1 and data a3. The receiving server 2 takes out data received by the receiving end mail server 4, and performs the following processing.

The data diverting section 211 determines whether or not the data is from the registered sending source. If the data is from the branch terminals 5a, 5b, the data is passed to the reception management section 213, in which the data c of unregistered subscriber is stored in the unregistered data storage section 212. The reception management section 213 extracts the predetermined information such as the time (sending date), serial number, message ID, sending source address, identifier of sending server 1, and file name of data from the sending data information in the mail header of data diverted by the data diverting section 211, and records the information in the reception management table 214.

The security verification section 215 performs the security verification by decoding the data passed from the data diverting section 211 and making signature authentication. Herein, when the security verification for data b1 is successful, the data b1 is stored in the received data storage section 22. The reception management section 213 registers the record receiving status of data b1, “received”, and the storage position (directory name, file name and so on) of data b1 in the received data storage section 22. Thereafter, data b2 from the same sending source is processed, like data b1, and stored in the received data storage section 22. On the other hand, when the security verification data (decoding key or signature authentication data) is falsely set up, the security verification in the security verification section 215 may fail. For example, suppose that the decoding of data a1 fails in security verification.

The security verification section 215 stores the data a1 in the unverified data temporary storage section 217 to temporarily save it, and records the storage position of data a1 and the cause of save (decoding error) in the management table 23. Also, the reception management section 23 receives a notification of security verification failure, and records “decoding error” in the reason code and “unreceived” in the reception status for the record of data a1 in the reception management table 214.

Thereafter, for data a2 and data a3 passed from the data diverting section 211, the security verification section 215 updates the settings of security verification data at the branch terminal 5a and succeeds in the decoding and signature authentication.

However, since the security verification for the data a1 sent from the same sending destination (branch terminal 5a) fails, the security verification section 215 stores or saves the data a2 and data a3 in the rearrangement storage section 216, and records the identification information of data a2 and data a3 and the cause of save (saving the data a1) in the management table 23. Also, the reception management section 213 receives a notification of successful security verification, and records “decoded” in the verification status and “unreceived” in the reception status for the records of data a2 and data a3 in the reception management table 214.

The management table monitoring section 24 monitors the management table 23, and requests the security verification section 215 to make the security verification for data a1 from the cause of saving the data a1 (verification failure) and the causes of saving the data a2 and data a3 (saving the data a1). The security verification section 215 takes out the data a1 stored in the unverified data temporary storage section 217 and makes the security verification again. If the security verification for data a1 is successful, the decoded data a1 is stored in the received data storage section 22, the already decoded data a2 and data a3 are moved from the rearrangement storage section 216 to the received data storage section 22, and the corresponding record is deleted from the management table 23. Moreover, the reception management section 213 changes the reception status to “received” for the records of data a1, data a2 and data a3 in the reception management table 214, and records the storage position in the received data storage section 22. In the received data storage section 22, though the already decoded data (b1, b2) from the branch terminal 5b are stored in the sequence of serial number, the data (a1, a2, a3) from the branch terminal 5a are also stored in the sequence of serial number.

Thereby, at the order receiving administrative terminal 6, referring to the received data in the received data storage section 22 always takes place according to the send sequence, preventing the occurrence of a situation where the preceding data a in the send sequence is not received and the succeeding data a2 and data a3 are received ahead.

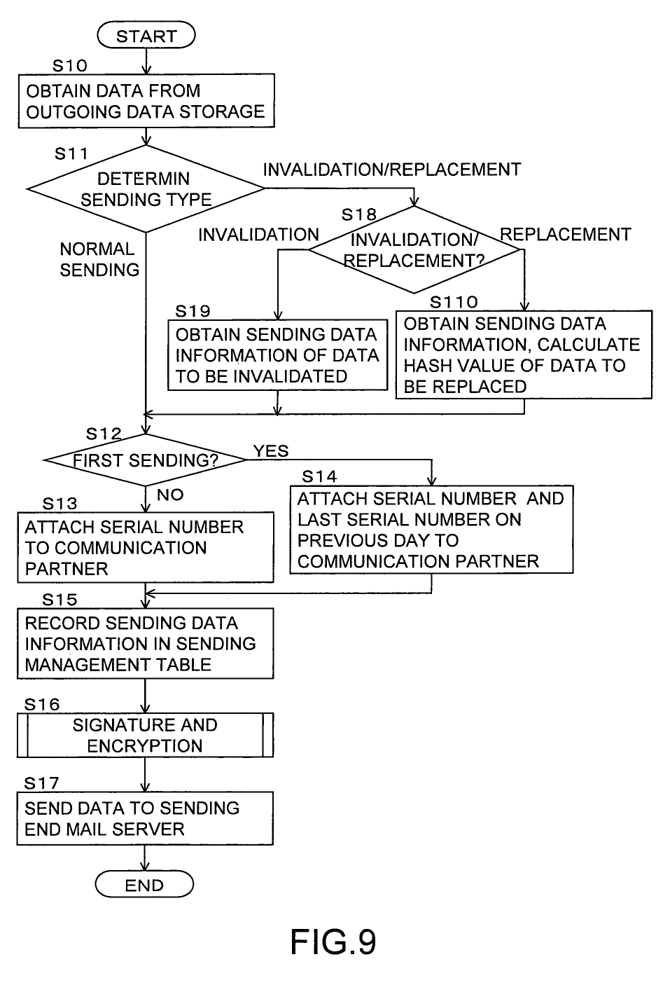

FIGS. 9 to 11 show the processing flows of the present invention. FIG. 9 is a flowchart showing a processing flow of the sending server 1.

At the sending server 1, the sending processing section 141 obtains the un-sent data from the outgoing data storage section 13 (step S10). Then, it is determined whether the sending type of data is normal data sending, or invalidation request or replacement request (step S11). If the sending type of data is normal data sending, it is determined whether or not the sending is the first sending on that day (sending date) (step S12). If not the first sending on that day, the serial number for each communication partner is appended to the transmit data (step S13). On the other hand, the serial number for each communication partner and the last serial number on the previous day are appended to the sending data information by referring to the sending management table 143 via the sending management section 142 (step S14). The sending management section 142 records the sending data information in the sending management table 143 (step S15). Thereafter, the sending processing section 141 performs the signature authentication and encryption for the outgoing data (step S16), and sends the encrypted data to the sending end mail server 3 (step S17). Then, the procedure is ended.

On the other hand, at step S11, if the sending type is the invalidation request or replacement request, the request type is further discriminated (step S18). If the request type is invalidation, the sending processing section 141 obtains the sending data information of data to be invalidated from the sending management table 143 via the sending management section 142 (step S19). Thereafter, steps S12 to step S17 are performed. Then, the procedure is ended. Also, if the request type is replacement, the sending processing section 141 obtains the sending data information of data to be replaced from the sending management table 143 via the sending management section 142, and obtains the hash value of data to be replaced that is stored in the outgoing data storage section 13 (step S110). Thereafter, steps S12 to step S17 are performed. Then, the procedure is ended.

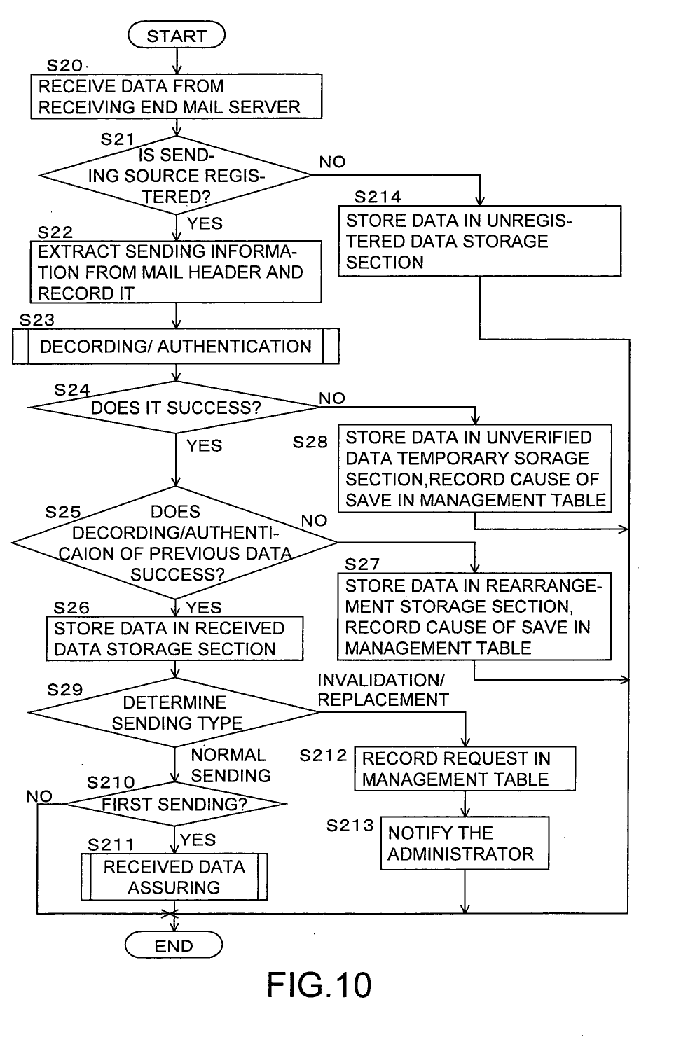

FIG. 10 is a flowchart showing a processing flow of the receiving server 2.

At the receiving server 2, data is received from the receiving end mail server 4 (step S20). The data diverting section 211 determines whether or not the sending source is registered (step S21). If the sending source is registered, the reception management section 213 extracts the sending data information of the mail header, and records it in the reception management table 214 (step S22).

Moreover, the security verification section 215 performs the decoding and signature authentication processing for the data (step S23). If the processing is successful (step S24), it is determined whether or not the decoding and signature authentication processing for the data received ahead of this data is successful (step S25). If the processing for the previous data is successful, the data is stored in the received data storage section 22 (step S26). On the other hand, if the processing for the previous data is not successful, the data is stored in the rearrangement storage section 216, and the cause of save is recorded in the management table 23 (step S27). Then, the procedure is ended.

Also, if the decoding and signature authentication processing at step S23 is not successful (step S24), the data is stored in the unverified data temporary storage section 217, and the cause of save is recorded in the management table 23 (step S28). Then, the procedure is ended.

Thereafter, the reception management section 213 determines the sending type of the received data (step S29). If the sending type is normal, it is determined whether or not the received data takes place on the first sending (step S210). If the first sending is made by the resending request section 221 of the received data assuring section 220, a received data assuring process is performed (step S211). On the other hand, if the sending type is the invalidation request or replacement request, the request is recorded in the management table 23 (step S212). Thereafter, the management table monitoring section 24 monitors the management table and notifies the request to the administrator (step S213). Also, if the sending source of data is not registered at step S21, the data is stored in the unregistered data storage section (step S214). Then, the procedure is ended.

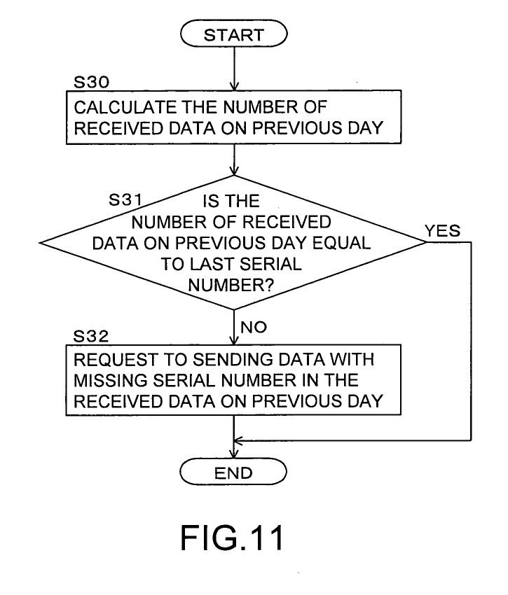

FIG. 11 shows a processing flow of the received data assuring process at step S211 in FIG. 10.

The resending request section 221 calculates the number of received data on the previous day of the sending date by referring to the reception management table 214 (step S30). If the number of received data on the previous day is not equal to the last serial number (step S31), a resending request for the data with missing serial number in the received data on the previous day is made to the sending server 1 (step S32), and the procedure is returned.

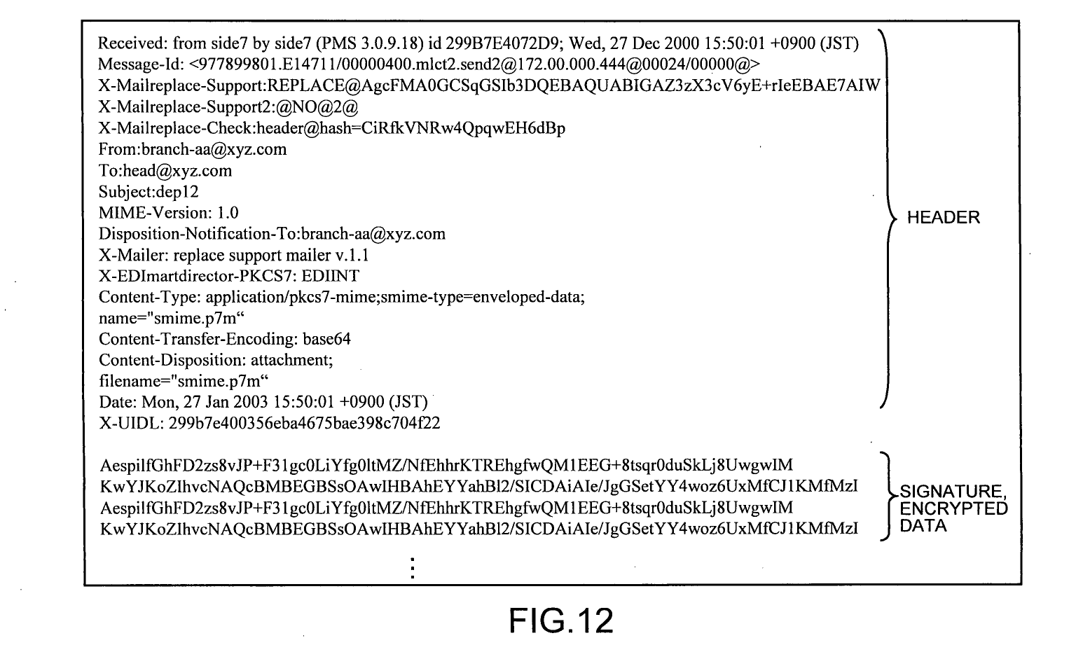

FIG. 12 shows an example of data in the mail format that is created in the sending control section 14 at the sending server 1. In the data as shown in FIG. 12, the predetermined sending data information such as sending date and time, identification information of sending destination, serial number, and the last serial number on the previous day is set up in a part of the mail header. Also, the security verification information such as signature data and the encrypted data of message ID is set up in a part following the header.

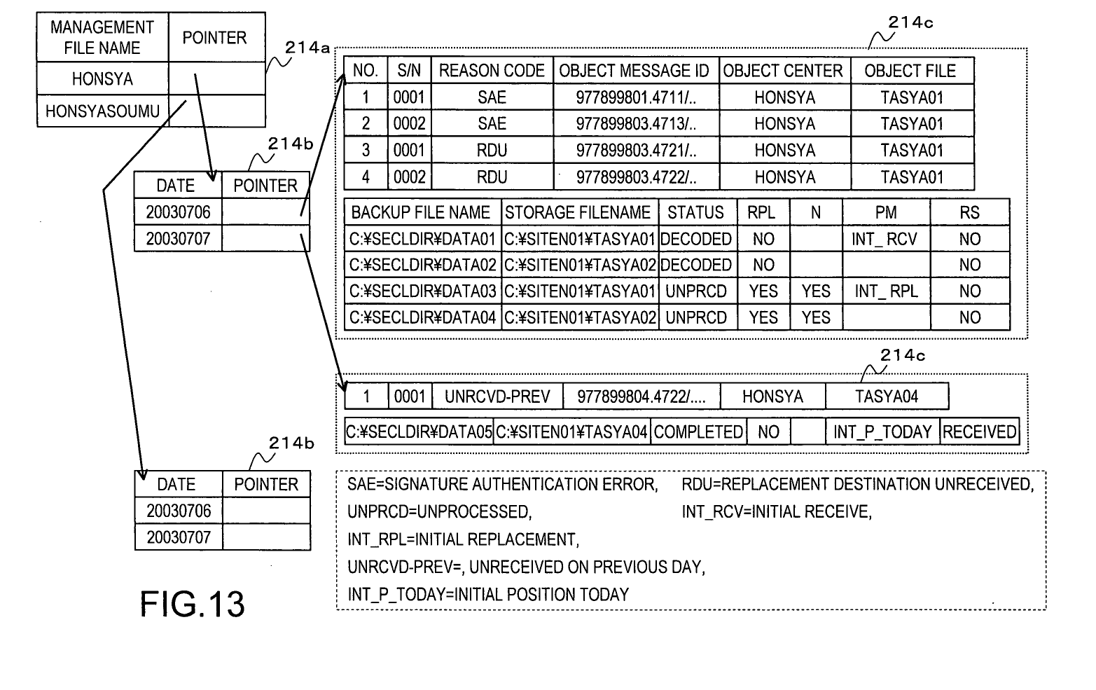

FIG. 13 shows an example of data recorded in the reception management table 214. In the reception management table 214, every time the receiving server 2 receives the data from the registered branch terminal 5, the predetermined information extracted from the received data is stored in the actual data management table 214c via the communication partner management table 214a and the date unit management table 214b for managing the data exchange in a unit of date. Moreover, the reason code, backup file name, storage file name, data processing condition (status), position management, and reception status (receive) when reception is disabled are set up in the actual data management table 214c.

The actual data management table 214c corresponding to date=20030706 in the date unit management table 214b indicates that four data are received. In the actual data management table 214c, the record with number=1 indicates the data firstly taken out by the receiving server 2 is decoded, but saved in the unverified data temporary storage section 217 due to a signature authentication error, and not stored in the received data storage section 22. Also, the record with number=2 indicates that the data taken out at the second time is saved in the rearrangement storage section 216 due to the signature authentication error of the first data and not stored in the received data storage section 22. The record with number=3 indicates that the replacement request is taken out at the third time by the receiving server 2, and the replacement object is the data firstly taken out (number=1), namely, data with the serial number “0001”, in which the decoding/signature authentication processing and the replacement processing are not yet performed. The record with number=4 indicates that the replacement request for the data received at the second time (number=2, serial number=0002) is taken out, in which the decoding/signature authentication processing and the replacement processing are not yet performed.

The actual data management table 214c corresponding to date=20030707 in the date unit management table 214b indicates that one data is received. In the actual data management table 214c, the record with number=1 indicates that the data is firstly taken out by the receiving server 2, in which the data firstly sent on the sending date succeeds in the decoding/signature authentication, and is stored in the received data storage section 22. The received data assuring process on the previous day is performed based on the last serial number on the previous day that is set up on this data.

Though this invention has been described above in connection with the embodiment, it will be apparent that various variations or modifications may be made thereto without departing from the scope or spirit of the invention. For example, in this embodiment, the sending end mail server 3 and the receiving end mail server 4 are in the mail exchange system using the SMTP and POP as the receiving/sending protocol, and the sending server 1 and the receiving server 2 process the mail using the SMTP and POP. However, the sending server 1 and the receiving server 2 may perform the same processing using another protocol useful in the data exchange system with asynchronous data exchange.

Also, the present invention may be performed as a processing program or script that is read and executed by the computer. The processing program for implementing this invention is stored in appropriate computer readable recording medium, such as a portable medium memory, a semiconductor memory, or a hard disk. The processing program may be recorded and provided in the recording medium, or distributed via the communication interface over the communication network.

The invention may be embodied in other specific forms without departing from the spirit of essential characteristics thereof. The present embodiments are therefore to be considered in all respects as illustrative and not restrictive, the scope of the invention being indicated by the appended claims rather than by foregoing description and all changes which come within the meaning and range of equivalency of the claims are therefore intended to be embraced therein.

1. A sending server data exchange processing method for exchanging data regarding an electronic commerce transaction between the sending server and the receiving server, in which the sending server and the receiving server exchange data asynchronously through an electronic mail system, the method comprising:
a step of appending, to the transmit data, the sending data information including the sending destination information of data, the identification information of the sending server, the identification information of the receiving server, the sending day indicating the month and date when data is sent, the serial number indicating the send sequence of data to each sending destination on the same sending day in consecutive number, and the last serial number that is the serial number of data sent lastly on the previous day of the sending day;
a step of performing a security verification for the data;
a step of sending the data;
a step of recording the sending data information in a sending management table;
a step of storing data sent on the sending day and the previous day in a outgoing data storage section; and
a step of taking out the corresponding data of resending object from the outgoing data storage section, employing the sending day and the serial number, and mailing the data of resending object to the receiving server, when a sending request for data specified by the sending day and the serial number is received from the receiving server.

2. The sending server data exchange processing method according to claim 1, wherein the step of sending the data, either an invalidation request for invalidating data received and stored within a self-server or a replacement request for replacing the data with the other data, is sent to the receiving server together with the sending day and the serial number for specifying a request object.

3. A receiving server data exchange processing method for exchanging data regarding an electronic commerce transaction between the sending server and the receiving server, in which the sending server and the receiving server exchange data asynchronously through an electronic mail system, the method comprising:
a step of taking out, from a mail server of the electronic mail system, data appended with the sending data information including the sending source information of data, the identification information of the sending server, the identification information of the receiving server, the sending day indicating the month and date when data is sent, the serial number indicating the send sequence of data to each sending destination on the same sending day in consecutive number, and the last serial number that is the serial number of data sent lastly on the previous day of the sending day;
a step of recording the sending data information appended to the data and the information managing a receiving situation in a reception management table;
a step of performing a security verification for the data;
a step of storing successful data of the security verification in a received data storage section; and
a step of acquiring the last serial number of the data, when the serial number of the data indicates the first sending on the sending day, and extracting the missing serial number from the serial numbers of data received on the previous day and mailing a resending request for data corresponding to the missing serial number to the sending server, when the last serial number is unequal to the number of received data on the previous day of the sending day that are recorded in the reception management table.

4. The receiving server data exchange processing method according to claim 3, further comprising:
a step of deleting the corresponding data from the received data storage section if there is an invalidation request or replacing the corresponding data in the received data storage section with another data, if there is a replacement request, when the invalidation or replacement request for data specified by the sending day and the serial number and stored in the received data storage section is received from the sending server.

5. The receiving server data exchange processing method according to claim 3, wherein the step of performing the security verification process further comprising:
a step of storing and saving the data in an unverified data temporary storage section, and recording the identification information of the data and a cause of save in the management table, when the security verification for the data fails;
a step of storing and saving the data sent consecutively from the same sending source as the data and succeeding in the security verification in the rearrangement storage section, and recording the identification information of the data and a cause of save in the management table; and
a step of storing the data saved in the unverified data temporary storage section and the data saved in the rearrangement storage section in the received data storage section, when the data saved in the unverified data temporary storage section succeeds in the security verification.

6. A recording medium recording a sending server data exchange processing program for enabling a sending server to make a data exchange process for exchanging data regarding an electronic commerce transaction between the sending server and the receiving server, in which the sending server and the receiving server exchange data asynchronously through an electronic mail system, the data exchange process comprising:
a step of appending, to the transmit data, the sending data information including the sending destination information of data, the identification information of the sending server, the identification information of the receiving server, the sending day indicating the month and date when data is sent, the serial number indicating the send sequence of data to each sending destination on the same sending day in consecutive number, and the last serial number that is the serial number of data sent lastly on the previous day of the sending day;
a step of performing a security verification for the data;
a step of mailing the data;
a step of recording the sending data information in a sending management table;
a step of storing data sent on the sending day and the previous day in a outgoing data storage section; and
a step of taking out the corresponding data of resending object from the outgoing data storage section, employing the sending day and the serial number, and mailing the data of resending object to the receiving server, when a sending request for data specified by the sending day and the serial number is received from the receiving server.

7. A recording medium recording a receiving server data exchange processing program for enabling a receiving server to make a data exchange process for exchanging data regarding an electronic commerce transaction between the sending server and the receiving server, in which the sending server and the receiving server exchange data asynchronously through an electronic mail system, the data exchange process comprising:
a step of taking out, from a mail server of the electronic mail system, data appended with the sending data information including the sending source information of data, the identification information of the sending server, the identification information of the receiving server, the sending day indicating the month and date when data is sent, the serial number indicating the send sequence of data to each sending destination on the same sending day in consecutive number, and the last serial number that is the serial number of data sent lastly on the previous day of the sending day;
a step of recording the sending data information appended to the data and the information managing a receiving situation in a reception management table;
a step of performing a security verification for the data;
a step of storing successful data of the security verification in a received data storage section; and
a step of acquiring the last serial number of the data, when the serial number of the data indicates the first sending on the sending day, and extracting the missing serial number from the serial numbers of data received on the previous day and mailing a resending request for data corresponding to the missing serial number to the sending server, when the last serial number is unequal to the number of received data on the previous day of the sending day that are recorded in the reception management table.

8. A data exchange processing method for exchanging data regarding an electronic commerce transaction between the sending server and a receiving server, in which the sending server and the receiving server exchange data asynchronously through an electronic mail system, the method comprising:
at the sending server,
a step of appending, to the transmit data, the sending data information including the sending destination information of data, the identification information of the sending server, the identification information of the receiving server, the sending day indicating the month and date when data is sent, the serial number indicating the send sequence of data to each sending destination on the same sending day in consecutive number, and the last serial number that is the serial number of data sent lastly on the previous day of the sending day;
a step of performing a security verification for the data;
a step of mailing the data;
a step of recording the sending data information in a sending management table; and
a step of storing data sent on the sending day and the previous day in a outgoing data storage section;
and at the receiving server,
a step of taking out, from a mail server of the electronic mail system, data appended with the sending data information;
a step of recording the sending data information appended to the data and the information managing a receiving situation in a reception management table;
a step of performing a security verification for the data;
a step of storing successful data of the security verification in a received data storage section; and
a step of acquiring the last serial number of the data, when the serial number of the data indicates the first sending on the sending day, and extracting the missing serial number from the serial numbers of data received on the previous day and mailing a resending request for data corresponding to the missing serial number to the sending server, when the last serial number is unequal to the number of received data on the previous day of the sending day that are recorded in the reception management table; and
at the sending server,
a step of taking out the corresponding data of resending object from the outgoing data storage section, employing the sending day and the serial number, and mailing the data of resending object to the receiving server, when the resending request is received from the receiving server.

9. A sending server for exchanging data regarding an electronic commerce transaction asynchronously through an electronic mail system, comprising:
processing means for appending, to the transmit data, the sending data information including the sending destination information of data, the identification information of the sending server, the identification information of the receiving server, the sending day indicating the month and date when data is sent, the serial number indicating the send sequence of data to each sending destination on the same sending day in consecutive number, and the last serial number that is the serial number of data sent lastly on the previous day of the sending day;
processing means for performing a security verification for the data;
processing means for mailing the data;
processing means for recording the sending data information in a sending management table;
transmit data storing means for storing data sent on the sending day and the previous day; and
processing means for taking out the corresponding data of resending object from the transmit data storing means, employing the sending day and the serial number, and mailing the data of resending object to the receiving server, when a sending request for data specified by the sending day and the serial number is received from the receiving server.

10. A receiving server for exchanging data regarding an electronic commerce transaction asynchronously through an electronic mail system, comprising:
processing means for taking out, from a mail server of the electronic mail system, data appended with the sending data information including the sending source information of data, the identification information of the sending server, the identification information of the receiving server, the sending day indicating the month and date when data is sent, the serial number indicating the send sequence of data to each sending destination on the same sending day in consecutive number, and the last serial number that is the serial number of data sent lastly on the previous day of the sending day;
reception management table recording means for recording the sending data information appended to the data and the information managing a receiving situation;
processing means for performing a security verification for the data;
received data storing means for storing successful data of the security verification; and
processing means for acquiring the last serial number of the data, when the serial number of the data indicates the first sending on the sending day, and extracting the missing serial number from the serial numbers of data received on the previous day and mailing a resending request for data corresponding to the missing serial number to the sending server, when the last serial number is unequal to the number of received data on the previous day of the sending day that are recorded in the reception management table.

11. A sending server data exchange processing program for enabling a sending server to make a data exchange process for exchanging data regarding an electronic commerce transaction between the sending server and the receiving server, in which the sending server and the receiving server exchange data asynchronously through an electronic mail system, the data exchange process comprising:
a step of appending, to the transmit data, the sending data information including the sending destination information of data, the identification information of the sending server, the identification information of the receiving server, the sending day indicating the month and date when data is sent, the serial number indicating the send sequence of data to each sending destination on the same sending day in consecutive number, and the last serial number that is the serial number of data sent lastly on the previous day of the sending day;
a step of performing a security verification for the data;
a step of mailing the data;
a step of recording the sending data information in a sending management table;
a step of storing data sent on the sending day and the previous day in a outgoing data storage section; and
a step of taking out the corresponding data of resending object from the outgoing data storage section, employing the sending day and the serial number, and mailing the data of resending object to the receiving server, when a sending request for data specified by the sending day and the serial number is received from the receiving server.

12. The sending server data exchange processing program according to claim 11, wherein the program enables the sending server to mail either an invalidation request for invalidating data received and stored within a self-server or a replacement request for replacing the data with the other data, together with the sending day and the serial number for specifying a request object, to the receiving server.

13. A receiving server data exchange processing program for enabling a receiving server to make a data exchange process for exchanging data regarding an electronic commerce transaction between the sending server and the receiving server, in which the sending server and the receiving server exchange data asynchronously through an electronic mail system, the data exchange process comprising:
a step of taking out, from a mail server of the electronic mail system, data appended with the sending data information including the sending source information of data, the identification information of the sending server, the identification information of the receiving server, the sending day indicating the month and date when data is sent, the serial number indicating the send sequence of data to each sending destination on the same sending day in consecutive number, and the last serial number that is the serial number of data sent lastly on the previous day of the sending day;
a step of recording the sending data information appended to the data and the information managing a receiving situation in a reception management table;
a step of performing a security verification for the data;
a step of storing successful data of the security verification in a received data storage section; and
a step of acquiring the last serial number of the data, when the serial number of the data indicates the first sending on the sending day, and extracting the missing serial number from the serial numbers of data received on the previous day and mailing a resending request for data corresponding to the missing serial number to the sending server, when the last serial number is unequal to the number of received data on the previous day of the sending day that are recorded in the reception management table.

14. The receiving server data exchange processing program according to claim 13, wherein the program enables the receiving server to delete the corresponding data from the received data storage section if there is an invalidation request, or replace the corresponding data in the received data storage section with another data, if there is a replacement request, when the invalidation or replacement request for data specified by the sending day and the serial number and stored in the received data storage section is received from the sending server.

15. The receiving server data exchange processing program according to claim 13, wherein the program enables the receiving server to perform the security verification process, further comprising a step of storing and saving the data in an unverified data temporary storage section, and recording the identification information of the data and a cause of save in the management table, when the security verification for the data fails, a step of storing and saving the data sent consecutively from the same sending source as the data and succeeding in the security verification in the rearrangement storage section, and recording the identification information of the data and a cause of save in the management table, and a step of storing the data saved in the unverified data temporary storage section and the data saved in the rearrangement storage section in the received data storage section, when the data saved in the unverified data temporary storage section succeeds in the security verification.
